(19) United States
(12) Patent Application Publication
(10) Pub. No.: US 2025/0019794 A1
(43) Pub. Date: Jan. 16, 2025

(54) A METHOD FOR CONTINUOUS PRODUCTION OF MAGNESIUM METAL BY METALLOTHERMIC REDUCTION OF MAGNESIUM BEARING ORE AND CONDENSATINO OF LIQUID MAGNESIUM

(71) Applicant: BIG BLUE TECHNOLOGIES INC., Wheat Ridge, CO (US)

(72) Inventors: Boris CHUBUKOV, Boulder, CO (US); Nicholas SQUANDA, Lakewood, CO (US); Aaron PALUMBO, Denver, CO (US)

(21) Appl. No.: 18/716,917

(22) PCT Filed: Nov. 14, 2022
(86) PCT No.: PCT/US2022/079825

§ 371 Date: Jun. 5, 2024

Related U.S. Application Data
(60) Provisional application No. 63/279,845, filed on Nov. 16, 2021.

(51) Int. Cl. C22B 26/22; C22B 5/04; C22B 5/16

(52) U.S. Cl. CPC C22B 26/22; C22B 5/04; C22B 5/16

(57) ABSTRACT

A system and method for continuous production of Mg from metallothermic reduction of magnesium bearing ore from both the reactor side and condenser side of the system, using a separate collection vessel. The furnace is a heated tube through which a moving bed of tableted feed flows. The condenser is a common heat exchanger design (shell/tube, plate/plate, etc.) and uses a heat transfer liquid to cool and condense magnesium gas under vacuum or pressure conditions. The cooling medium can be molten salts or metals which are not in direct contact with the magnesium metal. Liquid magnesium flows from the condenser into a collection vessel for further processing. Continuous operation is achieved by supplying a constant feed of tablets into the furnace, producing a constant stream of Mg gas to the condenser. Magnesium liquid product is tapped periodically from the collection vessel.

### CROSS REFERENCE TO RELATED APPLICATIONS

This application claims the benefit of U.S. Provisional Patent Application No. 63/279,845 filed Nov. 16, 2021, the contents of which are hereby incorporated herein by reference for all purposes to the extent such contents do not conflict with the present disclosure.

### STATEMENT REGARDING FEDERALLY SPONSORED RESEARCH OR DEVELOPMENT

This invention was made with government support under grant number DE-AR0001484 awarded by the Advanced Research Projects Agency for Energy, a division of the U.S. Department of Energy. The government has certain rights in the invention.

### FIELD OF THE INVENTION

The present disclosure generally relates to the production and recovery of metals. More particularly, the disclosure relates to systems suitable for the production of magnesium metal, to components of systems, and to methods of using the systems and components.

### BACKGROUND

Pyrometallurgical magnesium (Mg) metal production has only been performed industrially as a batch operation. Three particular production processes, known as Pidgeon, Bolzano, and Magnatherm processes, all produce Mg metal in batch using ferrosilicon (FeSi) to reduce calcined dolomite. Although the batch sizes differ, product and slag removal between batches requires breaking the process vacuum or pressure seal and a variety of cleaning and loading operations. See, e.g., Sever, James C., and Marlyn Ballain. “Evolution of the Magnetherm Magnesium Reduction Process.” Magnesium Technology 2013. Springer, Cham, 2013, pp. 69-74.

Mg gas has been condensed directly into a mixed collection vessel of liquid Mg (U.S. Pat. No. 7,641,711). The collection vessel was maintained at the desired temperature using a burner and/or cooling air. A secondary condenser was also necessary to minimize the amount of Mg that evaporated from the condenser. Tapping of the magnesium metal also occurred directly from the primary condenser. The work was successful in that Mg metal was produced but this condenser design was never commercialized. It is possible that the condensation efficiency or operational difficulties prevented the technology from full scale deployment.

U.S. Pat. No. 3,505,063 demonstrated condensation of Mg gas into an Al/Mg alloy, at temperatures below the melting point of Mg by taking advantage of the lower melting point of the alloy. This minimized the Mg losses out of the condenser by reducing the extent of Mg evaporation from the liquid surface.

U.S. Pat. No. 5,258,055 also demonstrated condensation of metal vapor into a mixing and splashing pool of molten salts, with the salts floating on top of the molten metal. Here the molten salt cooling medium was in direct contact with process gas.

WO Publication 03/048398 also demonstrated collection of metal vapors into a collection crucible using molten metals or molten salts as a heat transfer medium. Metal vapors flowed directly into the collection crucible so that the metal vapor condensed onto the liquid metal surface and the surrounding walls.

These and other attempts at Mg metal condensation into liquid state have been documented and tested, yet none have reached commercial stage. The main challenges of such a technology include the tapping and/or removal of Mg from the collection vessel, the condensation efficiency and loss of Mg from the vapors leaving the collection vessel, and the operational difficulties associated with transporting liquids at elevated temperatures in a sealed environment. The volatile nature of Mg metal is often the cause of process blockages.

### SUMMARY

The present disclosure is directed to a continuous process of magnesium metal production and collection, the process utilizing a modified furnace and condenser.

For the furnace, tableted Mg-containing feed flows in a moving bed through the hot zone. A liquid slag is not generated, but rather, the residue is removed as a solid. Removal of the solid can be by auger, vibration, or any other method. The furnace can be heated by electricity (e.g., arc, resistance, induction, microwave), gas, solar, or by any other method. The furnace continually generates Mg metal vapor by a metallothermic reduction of the feed (e.g., Mg-containing ore). Commonly, magnesite and/or dolomite ores are used, but others such as serpentine or magnesia derived from sea water can be used as well. A reducing agent such as ferrosilicon (FeSi) can be used, but aluminum (Al), calcium carbide (CaC₂), or others can be used as well. The furnace operation, of having a continuous flow of material through the hot zone and removal of the residue as a solid, has not been used for magnesium metal production prior to now.

The condenser is a heat exchanger of common design, e.g., shell/tube, plate/plate, etc. A liquid medium cools the magnesium metal gas produced in the furnace; a molten salt may be used for this application, as well as molten metals. The cooling medium for the condenser is separate from the process and does not directly contact the process gas. That is, the condenser uses an indirect liquid cooling medium to condense Mg into a liquid state, e.g., at 650 to 900° C. Liquid Mg flows by gravity from the condenser into a collection vessel where it can accumulate and be continuously or periodically tapped.

For Mg to exist in a molten state, the pressure and temperature is above the triple point (650° C., 4 mBar). A higher pressure of Mg (g) favors condensation into a molten state, but a lower pressure eases the temperature requirements of ore reduction. A lower pressure reduces the driving force for Mg (g) condensation and a larger fraction of the product gas and is carried out of or past the condenser. Higher pressure reduces this loss but requires a higher temperature in the furnace and transfer tubing between furnace and condenser. Operating at a pressure between a moderate vacuum (e.g., 50 mBar) and atmospheric pressure (e.g., about 1000 mBar) allows a balance between these phenomena. By carefully controlling temperature in the cooling loop, the vapor losses out of the condenser are minimized while also minimizing the furnace temperature required. In some designs, a vacuum pressure (less than atmospheric pressure) of 100-200 mBar is preferred.

To facilitate complete chemical conversion of the ore and flow through the furnace, the ore and reductant can be pre-mixed together as powders. This mixture is then pressed into tablets which are then fed into the furnace. An inert gas, such as argon, can be used as a carrier gas to direct the magnesium metal gas produced in the furnace to the condenser.

### BRIEF DESCRIPTION OF THE DRAWING

FIG. 1 is a graphical representation of thermodynamic calculations of Mg production for aluminothermic reduction of MgO.

FIG. 2 is a graphical representation of thermodynamic calculations of Mg production for aluminothermic reduction of dolime (MgO·CaO).

FIG. 3 is a box diagram of an example system and process.

FIG. 4 is a schematic diagram of an example system, having an arc furnace to heat the ore and reductant, and a shell/tube heat exchanger using molten salt to cool the product Mg gas.

### DETAILED DESCRIPTION

As summarized above, the present disclosure is directed to a continuous process of magnesium metal production and collection. The system utilizes a furnace having a continuous flow of material through the hot zone and removal of the residue as a solid, and a condenser using an indirect liquid cooling medium to condense Mg into a liquid state, and a collection vessel to collect the Mg. Thus, described herein is a system and method for continuous production of Mg from metallothermic reduction of magnesium bearing ore from both the reactor side and condenser side of the system, using a separate collection vessel.

Aluminothermic reduction of calcined dolomite to Mg proceeds according to Reaction R1, provided below. Similarly, the aluminothermic reduction of magnesia to Mg proceeds according to Reaction R2.

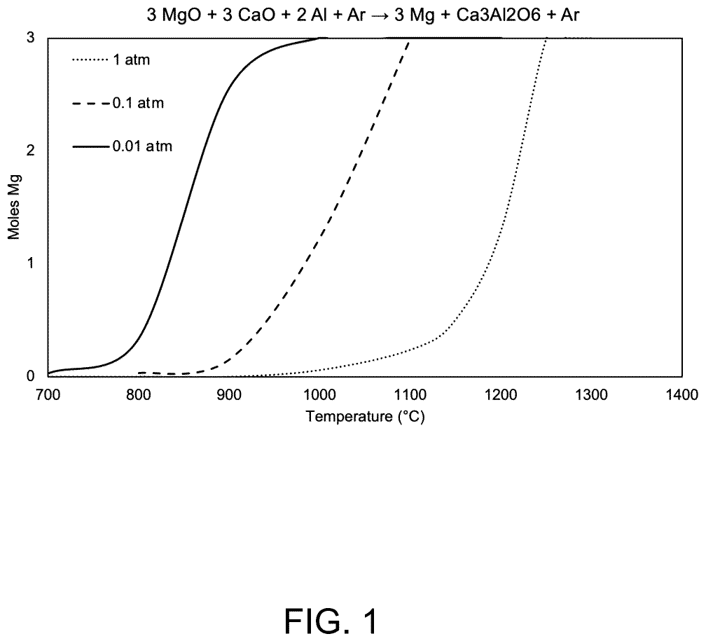

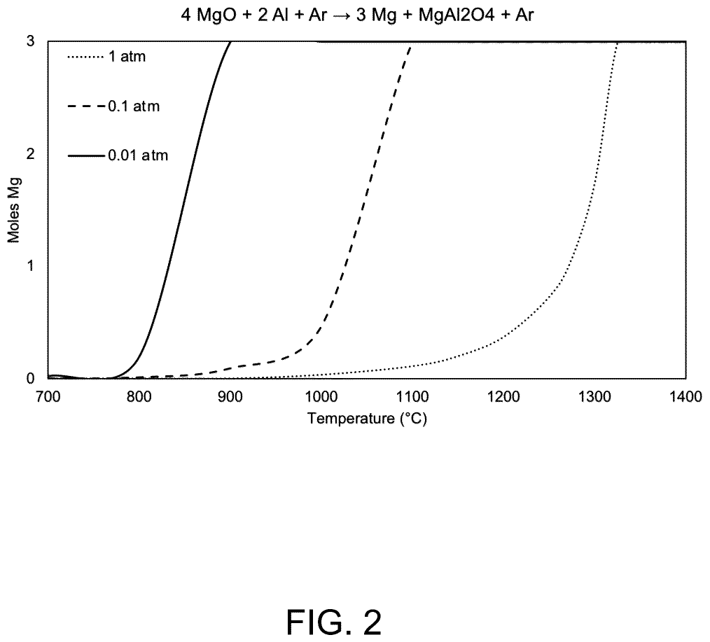

FIG. 1 and FIG. 2 show the thermodynamic equilibrium for magnesium metal produced in a closed system at various temperatures and pressures for Reaction R1 and Reaction R2. Using calcined dolomite, all the magnesium in the ore is thermodynamically favored to form metallic magnesium and the solid byproduct is calcium aluminate. Using magnesia, only 75% of the atomic magnesium in the ore is thermodynamically favored to form metallic magnesium where the remainder forms the solid byproduct magnesium aluminate spinel. From FIGS. 1 and 2, lowering the pressure of the system minimizes the temperature required to drive the reaction forward. A lower furnace temperature is favorable to maintain flow of the pellets through the reactor, mitigating fusion and/or sintering.

3MgO+2CaO+2Al→3Mg+Ca₃Al₂O₆ (R1)

4MgO+2Al→3Mg+MgAl₂O₄ (R2)

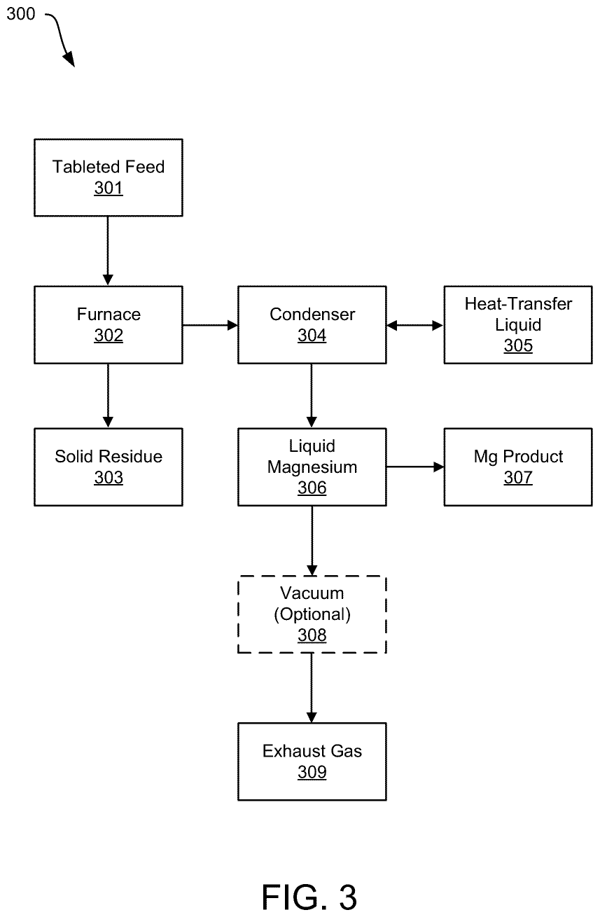

A generalized block flow diagram of a system and process 300 is shown in FIG. 3. All process steps can be operated continuously or semi-continuously. Tableted feed 301, which includes an Mg-containing component, is fed to a furnace 302 to perform a reduction reaction such as either R1 or R2, above. The solid byproduct 303 is removed from the furnace 302 as a residue while vapor magnesium flows into a condenser 304; the solid byproduct 303 may go one direction and the vapor magnesium may flow in another direction.

Liquid magnesium metal 306 is removed, e.g., continuously or semi-continuously, from the condenser 304 to a vessel and casted into a desired form 307, such as an ingot. The condenser 304 is operated with a liquid heat-transfer fluid 305 to cool the magnesium from vapor to liquid within the condenser 304. A vacuum pump 308 is optionally used to reduce the pressure of the system and decrease the required operating temperature of the reduction furnace. In a preferred process, any or all of the furnace 302, condenser 304, the vessel, and the system 300 overall, are below atmospheric pressure (e.g., at a vacuum yet greater than 100 mbar or greater than 500 mbar). The exhaust gas 309, e.g., argon, flows out with the magnesium and can be collected and recycled.

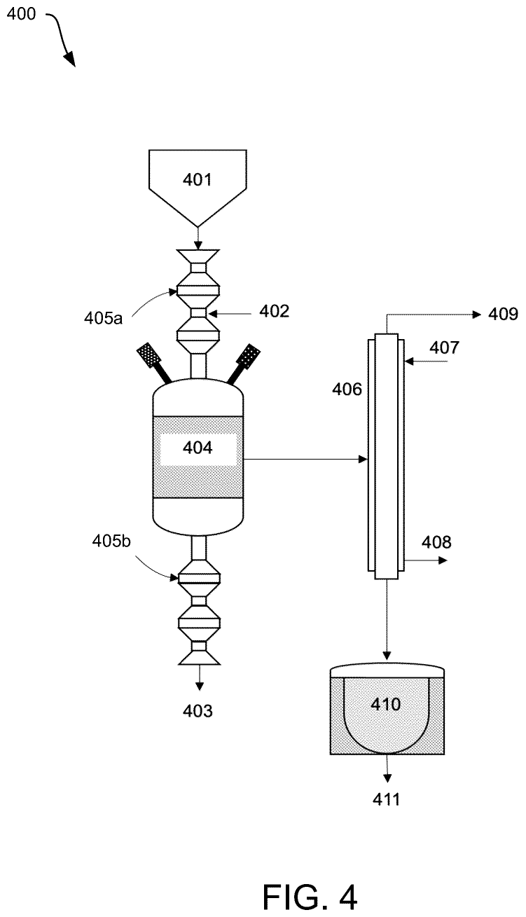

FIG. 4 shows a system 400 including a reduction furnace and a condenser.

Tableted or pelleted reactants are placed in a staging vessel 401 at an input side or end of a reduction furnace 404; typically, the staging vessel 401 is physically located above the reduction furnace 404, to utilize gravity to move the fed reactants from the staging vessel 401 to the furnace 404. A first lock hopper 405a is positioned between the staging vessel 401 and the furnace 404. An input 402 for an inert gas, such as argon, is also at the input side of the reduction furnace 404, shown as positioned to input into the lock hopper 405a, although it may be directly into the furnace 404.

Using the lock-hopper 405a and a conveyance mechanism such as an auger, the reactants are fed (e.g., continuously) into the furnace 404 without exposing the system to the ambient atmosphere.

The furnace 404 provides heating for the reduction reaction in a range of 800° C. to 1600° C., or in a range of 1000° C. to 1400° C., and in one embodiment around 1200° C. In one embodiment, the furnace 404 is an electric arc furnace, heated using two top-entry graphite electrodes. Other furnaces and heating methods may be used.

A reducing agent may optionally be fed into the furnace 404 to facilitate the conversion of MgO to Mg. Examples of suitable reducing agents include FeSi, Al, Ca/Si alloy, Ca/Al alloy, CaC₂, and other carbides.

An inert gas, such as argon, flow into the system via the inlet 402 flows into the system to help carry the magnesium vapor product to the condenser. Pure magnesium vapor flows in one direction, while the solid byproduct 403 is continuously removed through the bottom of the furnace, e.g., using an auger and one or more lock-hoppers 405b.

The pressure in the furnace 404 may be a vacuum or near vacuum, atmospheric pressure, or an elevated pressure.

A filter may be present in the furnace 404 or otherwise between the furnace 404 and the condenser 406 to minimize the transfer of solid particles to the condenser 406.

The condenser 406 can be an indirect condenser of conventional design, such as shell/tube (or, tube-and-shell) or plate/plate. In one embodiment, the condenser 406 has a single tube-and-shell design, however, a heat exchanger with multiple tubes or other conventional design may be used.

In the condenser 406, the shell-side accommodates the flow of a heat transfer fluid, such as a molten metal (e.g., lead, tin, bismuth, etc.), molten salt (e.g., nitrates, chlorides, fluorides, etc.), oil, high-pressure steam/water, and/or air, via an inlet 407 and an outlet 408. The temperature along the length of the shell of the condenser 406 is maintained within a range of 650° C. to 900° C., in one embodiment, at 750° C. The pressure in the condenser 406 may be a vacuum or near vacuum, atmospheric pressure, or an elevated pressure. Exhaust gases 409, primarily the inert gas(es), e.g., argon, flow out the top of the condenser.

Magnesium vapor, from the furnace 404, enters the condenser 406 where it is condensed into a liquid that is continuously removed, e.g., via gravity out the bottom of the condenser 406, into a holding vessel 410. The holding vessel 410 can be periodically or continuously tapped to produce alloys or casted magnesium products 411. The pressure in the holding vessel 410 may be a vacuum or near vacuum, atmospheric pressure, or an elevated pressure.

In some embodiments, a secondary condenser (not shown) may be present between the condenser 406 and the holding vessel 410. The secondary condenser cools vapors leaving the condenser and promotes deposition into a solid state at temperatures below 650° C.

The system 400 is an example of a system that can be used for the continuous production of Mg metal by metallothermic reduction of magnesium bearing ore and subsequent condensation of Mg into a liquid state. In one embodiment, the system 400 has a furnace operated at a temperature between 800° C. and 1600° C. in which the reduction residue remains in the solid state, an auger or other device to remove (e.g., continuously) the residue without exposing the process to ambient atmosphere, an indirect, liquid cooled, condenser or heat exchanger capable of maintaining a temperature between 650° C. and 900° C. to condense magnesium in a liquid state, and a pump or tapping method to remove (e.g., continuously or periodically (as a batch)) liquid magnesium from the collection vessel without exposing the process to ambient atmosphere.

The resulting Mg, collected in the collection vessel, will be at least at least 90 wt-% pure Mg, in some embodiments at least 95 wt-% pure, and in some embodiments at least 99 wt-% pure.

The conversion of the input feed (e.g., magnesium bearing ore, having the Mg as MgO), is at least 50% conversion to Mg, in some embodiments at least 75%, in other embodiments at least 90% and even at least 95%.

Table 1, below, provides experimental results for aluminothermic reduction of MgO and MgO·CaO at various temperatures and pressures.

TABLE 1

| Operating Conditions | | | | | Results | |
|---|---|---|---|---|---|---|
| Temp | Pressure | Stoichiometry | | | Mass | MgO to |
| (° C.) | (mbar) | MgO | MgO•CaO | Al | Loss | Mg |
| 1000 | 1 | 4 | — | 2 | 30% | 67% |
| 1000 | 1 | — | 3 | 2 | 19% | 76% |
| 1200 | 100 | 4 | — | 2 | 36% | 79% |
| 1200 | 100 | — | 3 | 2 | 20% | 90% |
| 1400 | 950 | 4 | — | 2 | 37% | 83% |
| 1400 | 950 | — | 3 | 2 | 19% | 95% |

The experimental results in Table 1 demonstrate the conversion behavior of Reactions R1 and R2 at various temperatures and pressures.

For these experiments, powdered reactants were blended and tableted in the stoichiometric ratios listed. The solid byproducts from each reaction remained solid in the furnace during the reduction process, preserved their bulk morphology, and did not fuse together. Near stoichiometric conversion was shown for both reactions under vacuum and at atmospheric pressure under argon by increasing the reduction temperature.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

1. A method for continuous production of Mg metal by metallothermic reduction of magnesium bearing ore, the method comprising:
providing magnesium bearing ore and a reducing agent to a furnace operating between 800° C. and 1800° C.;
removing residue from the furnace;
directing magnesium vapor from the furnace to a fluid-cooled heat exchanger, and condensing the magnesium vapor to liquid magnesium at a temperature between 650° C. and 900° C. which flows into a collection vessel; and
removing the liquid magnesium from the collection vessel.

2. The method of claim 1 wherein the furnace operates between 1000° C. and 1400° C.

3. The method of claim 2 wherein the furnace operates at 1200° C.

4. The method of claim 1 wherein the fluid-cooled heat exchanger operates at a temperature between 650° C. and 900° C.

5. The method of claim 4 wherein the fluid-cooled heat exchanger operates at a temperature of 750° C.

6. The method of claim 1, wherein the fluid-cooled heat exchanger is a tube/shell heat exchanger.

7. The method of claim 1, wherein the reducing agent is one or more of FeSi, Al, Ca/Si alloy, Ca/Al alloy, CaC₂, another carbide, or any alloy thereof.

8. The method of claim 1, wherein liquid magnesium is removed continuously from the collection vessel.

9. The method of claim 1, wherein liquid magnesium is removed in batch from the collection vessel.

10. The method of claim 1, wherein the magnesium bearing ore is calcined magnesite, calcined dolomite, calcined brucite, calcined serpentine, magnesia derived from sea water, or any other ore containing oxidized magnesium.

11. The method in claim 1 wherein the furnace is operated as a moving bed in which the residue is removed in the solid state by auger, vibration, or conveyor.

12. The method of claim 1, wherein the method is done without exposure of the magnesium vapor or the liquid magnesium to the ambient atmosphere.

13. The method of claim 1, wherein each or any of the steps are done at a pressure greater than 4 mbar or greater than 500 mbar.

14. The method of claim 1, wherein each or any of the steps is under an argon atmosphere.

15. The system of claim 1 wherein the furnace is electrically heated by resistance, arc, induction or microwave heating.

16. The system of claim 1 wherein the furnace is heated by combustion or a fuel.

17. The system of claim 1 further comprising a secondary condenser configured to cool magnesium vapors from the heat exchanger and promote magnesium deposition into a solid state at temperatures below 650° C.

18. The system of claim 1 further comprising a filter operably positioned between the furnace and the heat exchanger to minimize the transfer of solid particles.
